(19) United States
(12) Patent Application Publication
(10) Pub. No.: US 2013/0067474 A1
(43) Pub. Date: Mar. 14, 2013

(54) LANGUAGE INDEPENDENT APPLICATION OBJECT

(71) Applicants: Christopher Edmonds, Carnation, WA (US); Elliot Omiya, Kirkland, WA (US); Mykola Dudar, Redmond, WA (US); Benjamin Robert Pryor, Sammamish, WA (US); Marco Matos, Seattle, WA (US); John Gossman, Seattle, WA (US)

(72) Inventors: Christopher Edmonds, Carnation, WA (US); Elliot Omiya, Kirkland, WA (US); Mykola Dudar, Redmond, WA (US); Benjamin Robert Pryor, Sammamish, WA (US); Marco Matos, Seattle, WA (US); John Gossman, Seattle, WA (US)

(73) Assignee: MICROSOFT CORPORATION, Redmond, WA (US)

(21) Appl. No.: 13/230,485

(22) Filed: Sep. 12, 2011

(51) Int. Cl. G06F 9/46

(52) U.S. Cl. 718/100

(57) ABSTRACT

Applications are managed on a computing device using a language independent application object. The computing device receives an indication that an application is to begin execution. Responsive to every indication that an application is to begin execution, a multi-thread aware singleton application object is instantiated within that application. The multi-thread aware singleton application object is configured to create a first application thread and a first application window for that application. The first application thread is associated with the first application window. The multi-thread aware singleton application object is configured to instantiate within an application regardless of a programming language or user interface framework utilized by that application.

### BACKGROUND

Applications developed for computing devices may participate in various operating system flows such as process lifetime, e.g., creation, suspension, resuming, and termination.

In some examples, the behavior of an application within an operating system and user interface framework may depend on how the application was programmed. For example, the application itself may handle thread and window creation and how the threads and windows are associated and controlled in a particular user interface framework or operating system.

However, each application programming language and user interface framework may handle such application interactions in a different manner and such applications may not work across multiple programming languages and frameworks. Namely, different applications may initialize and maintain lifetime in nonuniform and inconsistent ways in a given framework. Further, such applications may create multiple windows associated with a single application thread so that when one window is busy performing a process all other windows created by the application become unresponsive.

### SUMMARY

The present disclosure is directed to managing applications on a computing device using a language independent application object. In one example approach, the computing device receives an indication that an application is to begin execution. Responsive to every indication that an application is to begin execution, a multi-thread aware singleton application object is instantiated within that application. The multi-thread aware singleton application object is configured to create a first application thread and a first application window for that application. The first application thread is associated with the first application window. The multi-thread aware singleton application object is configured to instantiate within an application regardless of a programming language or user interface framework utilized by that application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an instance of a multi-thread aware singleton application object configured to create application threads and windows in accordance with an embodiment of the disclosure.

FIG. 2 shows an example method for managing applications on a computing device in accordance with an embodiment of the disclosure.

FIG. 3 schematically shows a nonlimiting computing system in accordance with an embodiment of the disclosure.

### DETAILED DESCRIPTION

The present disclosure is directed to managing applications on a computing device using a programming language and framework independent multi-thread aware singleton application object configured to create application threads and windows on behalf of applications installed on the computing device.

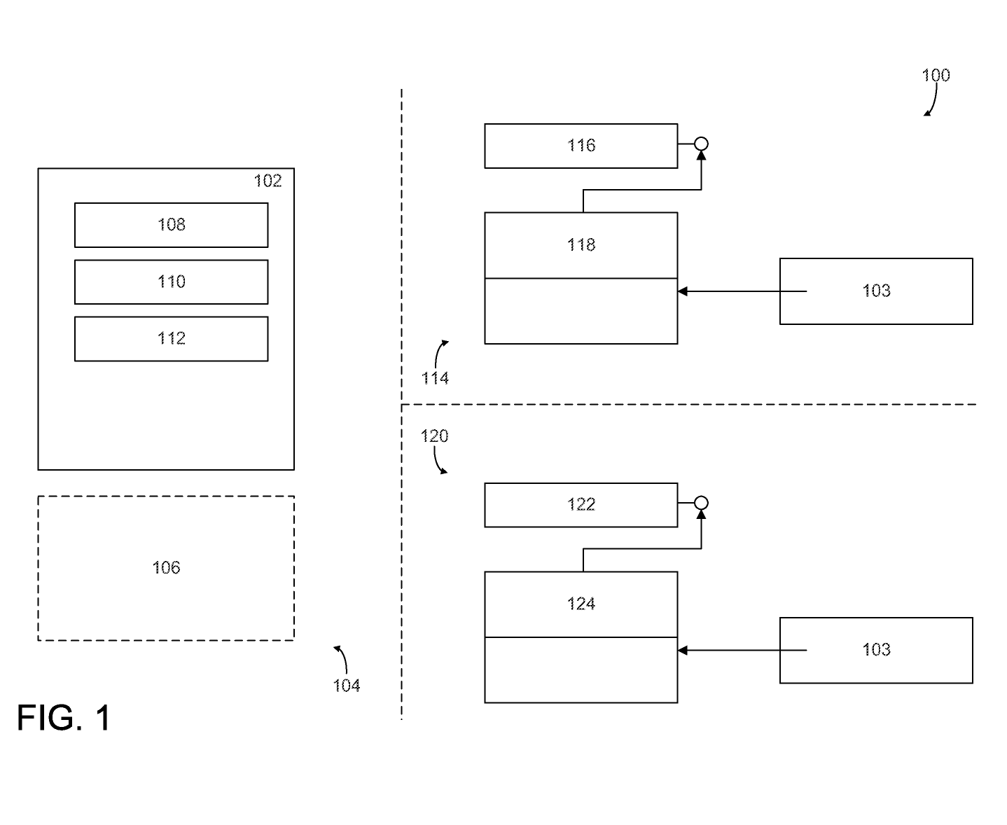

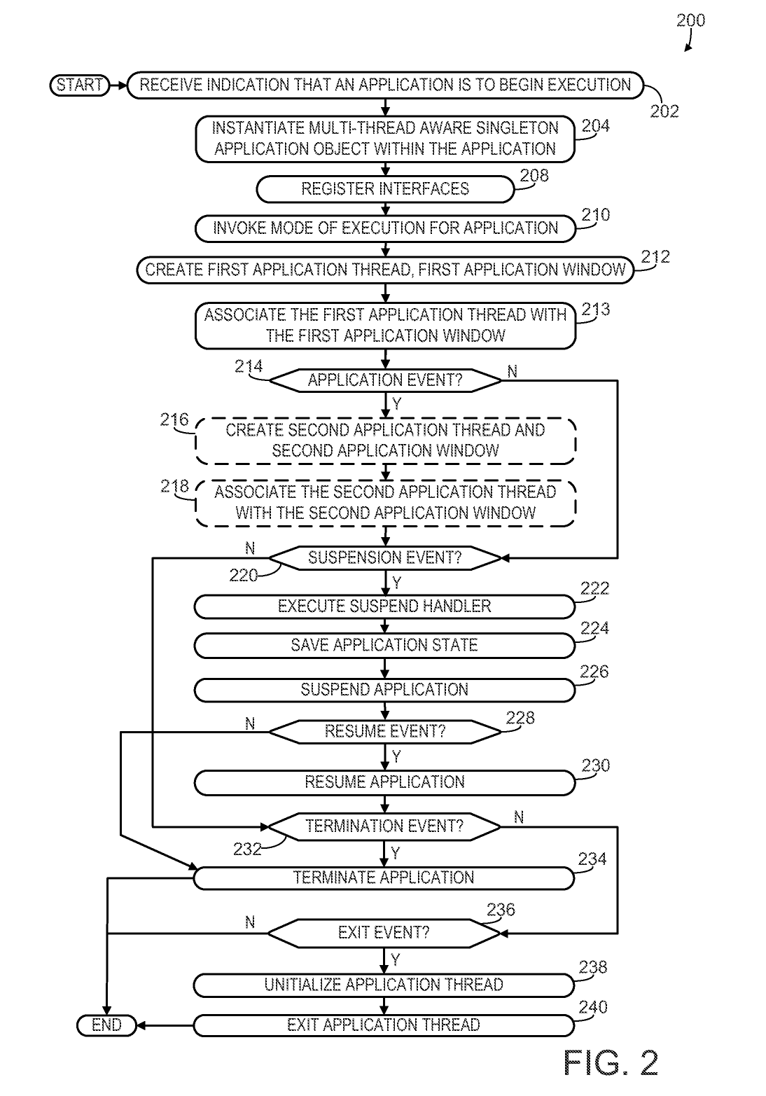

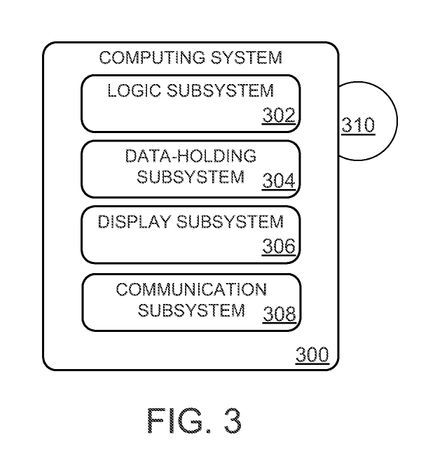

FIG. 1 illustrates an example embodiment 100 of a method 200, shown in FIG. 2, for managing applications on a computing device using a multi-thread aware singleton application object. In particular, FIG. 1 schematically shows a multi-thread aware singleton application object instance 102 of a multi-thread aware singleton application object instantiated in response to activating an application 103 on a computing device, such as computing system 300 of FIG. 3. In the description below, FIG. 1 will be described concurrently with FIG. 2 to illustrate the method shown in FIG. 2.

The multi-thread aware singleton application object is a per-process singleton present in an application developed for and installed within an operating system on a computing device. The multi-thread aware singleton application object is responsible for handling the lifetime, windowing, and other tasks common to applications. In particular, the multi-thread aware singleton application object enables user interface (UI) frameworks to manage application lifecycles and the ways in which applications come to life in a consistent manner. Further, the multi-thread aware singleton application object is independent of any particular programming language used in application code and is UI framework agnostic.

As described in more detail below with regard to FIGS. 1 and 2, a multi-thread aware singleton application object runs inside of each executed application in the system and coordinates how application threads operate, manages the lifetime of each application process, and handles suspension and termination of an application, e.g., to save power or maximize battery life. Further, in some examples, the multi-thread aware singleton application object enforces the use of a new thread for each window in an application and may provide lifetime management for static objects used in applications.

By managing application behavior on behalf of applications running on a computing device, the multi-thread aware singleton application object confers explicit control over the threading models used by the applications. Further, the multi-thread aware singleton application object may simplify the experience of building applications by exposing key application level constructs to developers in addition to providing for consistency and integration between different UI frameworks.

As described in more detail below, in response to an activation of an application, instances of the multi-thread aware singleton application object start life under the control of a thread that matches a particular set of specifications; namely, an instance of a multi-thread aware singleton application object is the master thread or the main thread of the application.

Turning to FIG. 2, at 202, method 200 includes receiving an indication that an application is to begin execution. In some examples, an indication that an application is to begin execution may include a mode of execution, or application contract, for the application.

For example, an application may have been installed and registered in an activation catalog by a user or administrator of a computing device. The activation catalog may include a specification of various possible modes of execution, or application contracts, for a particular installed application. For example, the activation catalog may include specifications by an application manifest that is co-resident with an application binary.

The operating system running on the computing device may receive a user input and interpret the user input into a contract activation specifying a particular mode of execution to employ in launching the application.

For example, the operating system may display various options to a user of the computing device, e.g., menu options, tiles, or the like may be displayed to guide a user of the computing device in activating a particular application. A user gesture such as a user touch or tap, keyboard or mouse input, or other suitable user input may then be received by the computing device and interpreted by the operating system as an activation contract for that application. For example, the application contract may specify how the chosen application is to be launched, e.g., tile launch, search, share, full screen mode, partial screen mode, etc.

Once the particular activation contract has been identified, the identified activation contract may interact with an activation manager in the system to determine various specifications on how the application will be brought to life. For example, based on information for that application in the activation catalog, an out of process activation may be performed by a suitable inter-process communication. A process loader in the operating system may bring the application process into memory and cause it to start running.

At 204, method 200 includes instantiating a multi-thread aware singleton application object within that application. For example, FIG. 1 shows a multi-thread aware singleton application object instance 102 of a multi-thread aware singleton application object within an application 103. The multi-thread aware singleton application object may be instantiated within an application regardless of a programming language or user interface framework utilized by that application.

For example, the operating system may initialize a multi-threaded apartment or first application thread so that a developer of an application may include a call to instantiate the multi-thread aware singleton application object within the application code, shown for example at 104 in FIG. 1. This instance of the multi-thread aware singleton application object is multi-thread aware and interfaces with the operating system framework 106. This multi-thread aware singleton application object instance is a singleton object and is configured to live for the entire lifetime of the process.

Application object instance 102 may be configured to control various application processes. For example, application object instance 102 may be configured to initialize and activate the application.

Further, as shown in FIG. 1, application object instance 102 may include various components or subroutines for managing the application 103. For example, application object instance 102 may include a policy lifetime manager 108, a view manager 110, and an activation router 112.

The policy lifetime manager 108 may be configured to monitor the operating system and manage suspension, resuming, and termination of the application in response to system events. The view manager 110 may be configured to manage the interfaces for consumption by the operating system by controlling windows and threads, for example. The activation router 112 may be configured to control activation of various application threads and windows, as described in more detail below.

The application object instance 102 interfaces with the code in operating system framework 106. Framework 106 includes a variety of functions for managing the user interface of the operating system. For example, framework 106 may be configured to activate a window factory to create windows in the system, to provide a view provider factory, and to provide a background work provider factory. For example, the view provider factory may be provided to the run method of the multi-thread aware singleton application object and the run method may register certain interfaces for consumption by the operating system. For example, the run method may register a contract activation interface and an interface to the multi-thread aware singleton application object itself.

At 204, method 200 may also include instantiating a global singleton object within the application. The global singleton object may be configured to maintain state for a plurality of application references or to maintain state during the lifetime of the application. For example, the global singleton object may be configured to hold objects provided by other operating system processes such that they can maintain state for the lifetime of the application or to hold references to operating system objects holding state.

For example, during the lifetime of the application, operating system functionality which is surfaced via interfaces on global state holders may appear to an application programmer in terms of “static objects” in the language they are using to write their application. These global state holders may have a lifetime substantially identical to the lifetime of the application process. Thus, the multi-thread aware singleton application object may be configured to provide a key-value store, e.g., a map or hashtable, that allows operating system objects to attach global singleton object instances of global state holders to the multi-thread aware singleton application object to provide guaranteed lifetime of the global singleton object. Here “guaranteed” means that the global singleton object lives as long as the application. This allows the global singleton objects to store state. In the absence of this mechanism, the global singleton object could go out of scope or otherwise be destroyed (losing its in-memory state) and the next reference to one of its properties or method may cause a new instance to be created without any of the state that was previously stored.

At 208, method 200 includes registering interfaces that contain methods invokable by the operating system. In particular, the multi-thread aware singleton application object is configured to register interfaces that contain methods invokable by the operating system. For example, the multi-thread aware singleton application object may register an interface that allows the operating system activation manager to indicate which application contract is being invoked. The multi-thread aware singleton application object may then send data, e.g., arguments, relevant to that particular contract.

At 210, method 200 includes invoking a mode of execution for the application, e.g., specifying which application contract. In particular, the multi-thread aware singleton application object is configured to invoke the mode of execution, or application contract, for the application by exposing the application contract and communicating with the operating system to cause invocation of an identified application contract. For example, a user may click on a tile or perform other suitable inputs or gestures and, in response, the operating system activation manager may cause the application to come to life. The activation manager may then wait for the activation interface to be published and then invoke a particular contract by calling a method on that published interface by exposing a particular interface that allows the invocation of a particular contract out of many possible contracts.

At 212, method 200 includes creating a first application thread and a first application window. In particular, the multi-thread aware singleton application object is configured to create the first application thread and the first application window for the application.

For example, if a first application contract would naturally bring up the “main window” of the application, as shown in FIG. 1, application object instance 102 creates a first single threaded apartment, or first application thread 114 based on the mode of execution for the application within which a first application window 116 is created. The first application thread is initialized into a single-threaded context and a view provider object 118 may be instantiated by framework 106. The view provider object may be a framework-agnostic abstraction designed to support a variety of frameworks and may be configured to create application windows, for example.

However, if the first contract is a “subsidiary contract”, e.g. a share to another application or search data managed by this application, a thread that would host the main window may be created and then the thread and window associated with the subsidiary contract may be created.

The multi-thread aware singleton application object is configured to guarantee that the application terminates when the first application thread terminates. For example the main or first application thread 114 of the application is capable of spawning multiple other threads and controls the lifetime of the application.

At 213, method 200 includes associating the first application thread with the first application window. In particular, the multi-thread aware singleton application object is configured to associate the first application thread with the first application window. In some examples, associating the first application thread with the first application window may depend on the contract invocation received by the application from the operating system activation manager.

While an application is being executed, certain application events or logic in the application itself may cause the application to turn to the multi-thread aware singleton application object to create new windows and threads. Thus, at the top of an event processing loop at 214, method 200 includes determining whether an application event has occurred. For example, the application event may be a user input or an application call by the application. As another example, determining whether an application event has occurred may include determining whether to create a new window or view in the application.

If an application event occurred at 214, method 200 may optionally proceed to steps 216 and 218 to create additional threads and windows as described below. However, in some examples, in response to an application event at 214, method 200 may proceed to step 220 described below to suspend an application without creating additional threads and windows.

Thus, if an application event occurred at 214, method 200 may optionally proceed to step 216. At 216, method 200 includes creating a second or additional application thread and a second or additional application window. In particular, the multi-thread aware singleton application object is configured to create a second application thread and duplicate the first application window to create a second application window, in response to an application event. For example, if the application is requesting windows to be created, a second application window may only be created if a first application window has been created from which the second application window is duplicated. However, in some examples, a second window may be created without duplication if a second activation contract is invoked.

For example, FIG. 1 shows a second single threaded apartment or second application thread 120 within which a second application window 122 is created by a second instance of a view provider object 124 instantiated by framework 106. The second application thread is initialized into a single-threaded context so that each window in application 103 may have its own thread of execution. It should be understood that there is no logical limit to the number of threads and related windows which may be created. However, the number of created threads and related windows may be limited by available resources in a particular computing system, e.g., the amount of available memory in the system.

At 218, method 200 may optionally include associating the second application thread with the second application window. In particular, the multi-thread aware singleton application object is configured to associate the second application thread with the second application window.

In order to maximize battery life or save power in a computing system executing the application, certain conditions or events under the control of the operating system's process lifetime manager may cause the application to be partially suspended.

Thus the multi-thread aware singleton application object may be configured to request that applications running on the system periodically, depending on suspension events in the system, enter a suspended state where the application code is prepared to enter a state where threads in the process are no longer scheduled. Thus, at 220, method 200 includes determining whether a suspension event has occurred.

If a suspension event occurred at 220, method 200 proceeds to step 222. At 222, method 200 includes executing a suspend handler. In particular, the multi-thread aware singleton application object is configured to execute a suspend handler which readies the application for a suspended state. The suspend handler may be configured to prepare the processes involved in an application for a suspended state. For example, the suspend handler may cause information associated with the application to be saved in preparation for suspension.

At 224, method 200 includes saving application state. In particular, the multi-thread aware singleton application object is configured to invoke suspend handlers that may save state information of the application in response to the raising of a suspension event. For example, temporal application states such as a current state of an application may be saved to a storage component on the computing device so that in the event the application is terminated and relaunched the application may return to the saved state.

At 226, method 200 includes suspending the application after the suspend handler finishes. In the suspended state, threads in the application processes may be blocked in a low level operating system wait primitive, for example.

Under certain condition, in response to resume events, an application in a suspended state may be resumed. For example, a computer coming out of hibernation may resume an application from a suspended state. Thus, at 228, method 200 includes determining if a resume event occurred. For example, if the policy lifetime manager 108 allows, the application can be fully resumed depending on one or more states of the system.

If a resume event does not occur at 228, method 200 may proceed to step 234 to terminate the application as described below. However, if a resume event occurred at 228, method 200 proceeds to step 230. At 230, method 200 includes resuming the application. In particular, the multi-thread aware singleton application object is configured to, in response to a resume event when the application is suspended, cause the application to resume. For example, the operating system wait primitive may be signaled and the application thread may start executing again.

In some cases, a suspended application may terminate rather than resume, for example depending on available system resources, power saving options, user input, etc. Thus, at 232, method 200 includes determining if a termination event has occurred.

If a termination event occurred at 232, method 200 proceeds to step 234. At 234, method 200 includes terminating the application. In particular, the multi-thread aware singleton application object is configured to, in response to a termination event when the application is suspended, cause the application to terminate.

For example, an application may exit “normally” via an explicit call to an exit method whereby all processes, including threads and windows, associated with the application are requested to quit and exit their message loops. When all single threaded apartments associated with windows have exited, the event holding the main thread of the application may be signaled and the main multi-threaded context, i.e., the first application thread, may be uninitialized and then terminated.

In some examples, it may be possible for the application to be forcefully, e.g., without explicit knowledge by application code, terminated by the policy lifetime manager. For example, the application may be in a suspended state and then forcefully terminated due to constraints on system resources.

Under some conditions, in response to exit events such as user inputs or calls from the application, one or more windows and threads associated with an application may be exited without exiting the application. Thus, at 236, method 200 includes determining if an exit event occurred at step 236.

If an exit event occurred at 236, method 200 proceeds to step 238. At 238, method 200 includes uninitializing an application thread of the application. For example, the second application thread 120 may be uninitialized by the multi-thread aware singleton application object.

At 240, method 200 includes exiting the uninitialized application thread. For example, following uninitialization of the second application thread the second application thread may be exited. In this example, the main or first application thread 114 may continue to run until a termination event occurs as described above.

In some embodiments, the above described methods and processes may be tied to a computing system including one or more computers. In particular, the methods and processes described herein may be implemented as a computer application, computer service, computer API, computer library, and/or other computer program product.

FIG. 3 schematically shows a nonlimiting computing system 300 that may perform one or more of the above described methods and processes. It is to be understood that virtually any computer architecture may be used without departing from the scope of this disclosure. In different embodiments, computing system 300 may take the form of a mainframe computer, server computer, desktop computer, laptop computer, tablet computer, home entertainment computer, network computing device, mobile computing device, mobile communication device, gaming device, etc.

Computing system 300 includes a logic subsystem 302 and a data-holding subsystem 304. Computing system 300 may optionally include a display subsystem 306, communication subsystem 308, and/or other components not shown in FIG. 3. Computing system 300 may also optionally include user input devices such as keyboards, mice, game controllers, cameras, microphones, and/or touch screens, for example.

Logic subsystem 302 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 304 may include one or more physical, non-transitory, devices configured to hold data and/or instructions executable by the logic subsystem to implement the herein described methods and processes. When such methods and processes are implemented, the state of data-holding subsystem 304 may be transformed (e.g., to hold different data).

Data-holding subsystem 304 may include removable media and/or built-in devices. Data-holding subsystem 304 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 304 may include devices with one or more of the following characteristics: volatile, nonvolatile, dynamic, static, read/write, read-only, random access, sequential access, location addressable, file addressable, and content addressable. In some embodiments, logic subsystem 302 and data-holding subsystem 304 may be integrated into one or more common devices, such as an application specific integrated circuit or a system on a chip.

FIG. 3 also shows an aspect of the data-holding subsystem in the form of removable computer-readable storage media 310, which may be used to store and/or transfer data and/or instructions executable to implement the herein described methods and processes. Removable computer-readable storage media 310 may take the form of CDs, DVDs, HD-DVDs, Blu-Ray Discs, EEPROMs, and/or floppy disks, among others.

It is to be appreciated that data-holding subsystem 304 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

When included, display subsystem 306 may be used to present a visual representation of data held by data-holding subsystem 304. As the herein described methods and processes change the data held by the data-holding subsystem, and thus transform the state of the data-holding subsystem, the state of display subsystem 306 may likewise be transformed to visually represent changes in the underlying data. Display subsystem 306 may include one or more display devices utilizing virtually any type of technology. Such display devices may be combined with logic subsystem 302 and/or data-holding subsystem 304 in a shared enclosure, or such display devices may be peripheral display devices.

When included, communication subsystem 308 may be configured to communicatively couple computing system 300 with one or more other computing devices. Communication subsystem 308 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing system 300 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for managing applications on a computing device, the method comprising:
receiving an indication that an application is to begin execution;
responsive to every indication that an application is to begin execution, instantiating a multi-thread aware singleton application object within that application, the multi-thread aware singleton application object configured to:
create a first application thread and a first application window for that application;
associate the first application thread with the first application window; and
instantiate within that application regardless of a programming language or user interface framework utilized by that application.

2. The method of claim 1, wherein the multi-thread aware singleton application object is further configured to, in response to an application event:
create an additional application thread;
duplicate the first application window to create an additional application window; and
associate the created application thread with the duplicated application window.

3. The method of claim 2, wherein the multi-thread aware singleton application object is further configured to register interfaces that contain methods invokable by the operating system.

4. The method of claim 2, wherein the application event is a user input or an application call by the application.

5. The method of claim 2, wherein the second application thread is initialized into a single-threaded context.

6. The method of claim 2, wherein the multi-thread aware singleton application object is further configured to cause the second application thread to be uninitialized and exit in response to an exit event.

7. The method of claim 1, wherein the multi-thread aware singleton application object is further configured to guarantee that the application terminates when the first application thread terminates.

8. The method of claim 1, wherein the multi-thread aware singleton application object is further configured to execute a suspend handler and suspend the application in response to identifying a suspension event.

9. The method of claim 8, wherein the multi-thread aware singleton application object is further configured to save state information of the application in response to identifying a suspension event.

10. The method of claim 1, wherein the multi-thread aware singleton application object is further configured to, in response to a resume event when the application is suspended, cause the application to resume.

11. The method of claim 1, wherein the multi-thread aware singleton application object is further configured to, in response to a termination event when the application is suspended, cause the application to terminate.

12. The method of claim 1, further comprising, instantiating a global singleton object within the application, the global singleton object configured to maintain state for a plurality of application references.

13. The method of claim 12, wherein the global singleton object is further configured to hold objects provided by other processes such that they can maintain state for the lifetime of the application.

14. The method of claim 1, wherein an indication that an application is to begin execution includes a mode of execution for the application.

15. The method of claim 14, wherein the multi-thread aware singleton application object is further configured to invoke the mode of execution for the application and create the first application thread based on the mode of execution for the application.

16. A method for managing applications on a computing device, the method comprising:
receiving an indication that an application is to begin execution;
responsive to every indication that an application is to begin execution, instantiating a multi-thread aware singleton application object within that application, the multi-thread aware singleton application object configured to:
register interfaces that contain methods invokable by the operating system;
create a first application thread and a first application window for that application;
associate the first application thread with the first application window;
instantiate within that application regardless of a programming language or user interface framework utilized by that application; and
in response to an application event:
create a second application thread;
duplicate the first application window to create a second application window; and
associate the second application thread with the second application window.

17. The method of claim 16, wherein the multi-thread aware singleton application object is further configured to guarantee that the application terminates when the first application thread terminates.

18. The method of claim 16, further comprising, configuring a global singleton object within the application, the global singleton object configured to hold references to operating system objects holding state.

19. A computing system, comprising:
a logic subsystem; and
a data-holding subsystem holding instructions executable by the logic subsystem to:
receive an indication that an application is to begin execution;
responsive to every indication that an application is to begin execution,
instantiating a multi-thread aware singleton application object within that application, the multi-thread aware singleton application object configured to:
register interfaces that contain methods invokable by the operating system;
create a first application thread and a first application window for that application;
associate the first application thread with the first application window; and
instantiate within that application regardless of a programming language or user interface framework utilized by that application.

20. The computing system of claim 1, wherein the multi-thread aware singleton application object is further configured to, in response to an application event:
create a second application thread;
duplicate the first application window to create a second application window; and
associate the second application thread with the second application window.
